(19) United States
(12) Patent Application Publication
(10) Pub. No.: US 2008/0196304 A1
(43) Pub. Date: Aug. 21, 2008

(54) PROTECTIVE COVER FOR VEGETATIVE MATERIAL AND ASSOCIATED METHODS

(75) Inventor: Michael Pope, North Venice, FL (US)

Correspondence Address: MYERS BIGEL SIBLEY & SAJOVEC, PO BOX 37428, RALEIGH, NC, 27627, US

(73) Assignee: Bethel Farms Ltd.

(21) Appl. No.: 12/019,770

(22) Filed: Jan. 25, 2008

Related U.S. Application Data
(60) Provisional application No. 60/890,032, filed on Feb. 15, 2007.

(51) Int. Cl. B65D 19/38; A01B 79/00

(52) U.S. Cl. 47/58.1 R; 206/597

(57) ABSTRACT

Lightweight, removable covers for harvested vegetative material, such as sod, stacked on a pallet are provided. A cover includes a top panel with side and end panels extending downwardly from the top panel to form an envelope shaped to fit snugly over the stacked material. The stacked material is arranged in a shape of predetermined length, breadth and height, and the envelope is configured to have a corresponding shape. The envelope surrounds the stacked material without enclosing the pallet. The length and breadth of each panel of the envelope corresponds to a respective portion of the shape of the stacked material. In addition, each panel comprises a flexible material that is impervious to moisture. An outside surface of each panel is light and heat-reflective to protect the covered material and an inside surface is non-reflective. One or more of the panels includes promotional and/or information indicia on an outside surface thereof.

### CROSS-REFERENCE TO RELATED APPLICATION

This application claims priority to U.S. Provisional Application Ser. No. 60/890,032, filed Feb. 15, 2007, the disclosure of which is incorporated by reference in its entirety.

### FIELD OF THE INVENTION

The present invention relates generally to covers and, more particularly, to covers for protecting material during storage and transportation.

### BACKGROUND OF THE INVENTION

Conventionally, sod is grown in large plots referred to as turf farms. When the grass is mature or ready to harvest, machinery is used to strip the sod from the ground and cut it into pieces of a size and shape suitable for handling. The harvested sod is conventionally stacked on a pallet for shipment. The harvested sod may be rolled into coils and stacked on a pallet or may be stacked on a pallet in a flat configuration. For example, harvested sod may be stacked in square blocks, such as 12×12 inches or 16×16 inches. A substantial quantity of sod can be stacked upon a pallet and can be readily shipped by truck.

During storage and transportation, it is desirable to protect sod from the elements and from dispersal. Conventionally, a tarpaulin is used to cover sod being transported. Unfortunately, tarpaulins can be cumbersome to install and remove. In addition, tarpaulins may be subjected to wind during transportation that may cause them to not sufficiently cover the stacked sod. Conventional tarpaulins may also not adequately maintain sod in a moist, fresh condition.

### SUMMARY

In view of the above discussion, lightweight, removable covers for harvested vegetative material, such as sod, stacked on a pallet are provided. The covers are designed to keep the material moist, green and fresh. According to some embodiments, a cover includes a top panel with side and end panels extending downwardly from the top panel to form an envelope shaped to fit snugly over the stacked material. The stacked material is arranged in a shape of predetermined length, breadth and height, and the cover is configured to have a corresponding shape. The cover surrounds the stacked material without enclosing the pallet. The length and breadth of each panel of the cover corresponds to a respective portion of the shape of the stacked material. In addition, the cover comprises a flexible material that is impervious to moisture, and an outside surface of the cover is light and heat-reflective to protect the covered material. For example, the outside surface of the cover may have an opaque, light color. In some embodiments, an inside surface of the cover is non-reflective. For example, the inside surface may have an opaque, dark color.

In some embodiments, one or more of the panels of a cover may include promotional and/or information indicia on an outside surface thereof. For example, instructional information that describes use and/or care of the vegetative material may be provided. A description of the covered material, for example, may also be provided. In some embodiments, the cover may include loops extending outwardly therefrom, for example, along panel edge portions thereof. These loops are configured to facilitate and removal of the cover.

According to some embodiments, a method of harvesting sod includes removing strips of sod from underlying soil, stacking the strips of sod on a pallet to form a shape having a predetermined length, breadth and height, and covering the stacked sod with a lightweight, removable cover. The cover includes a top panel, with side and end panels extending downwardly from the top panel to form an envelope shaped to fit snugly over the stacked sod without enclosing the pallet. The length and breadth of each panel corresponds to a respective portion of the shape of the stacked sod. The cover is a flexible material that is impervious to moisture, and has an outside surface that is light and heat-reflective.

A plurality of covered stacks of sod may be placed in adjacent, abutting relationship in an array. This arrangement further prevents the covers from blowing away during transport and also prevents displacement of the sod on each pallet.

In some embodiments, a plurality of covers described above can be provided on a roll that is rotatably secured to a sod harvesting apparatus. This arrangement provides ready access to the covers and facilitates protecting the harvested sod almost immediately after being stacked on a pallet.

### BRIEF DESCRIPTION OF THE DRAWINGS

FIG. 1 is a perspective view of a cover for harvested vegetative material, according to some embodiments.

FIG. 2A-2C illustrate methods of harvesting vegetative material, according to some embodiments.

FIG. 3 is a perspective view of a plurality of covered stacks of harvested vegetative material placed in adjacent, abutting relationship for transport, according to some embodiments.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the cover in use or operation in addition to the orientation depicted in the figures. For example, if the cover in the figures is inverted, elements described as “under” or “beneath” other elements or features would then be oriented “over” the other elements or features. Thus, the exemplary term “under” can encompass both an orientation of “over” and “under”. The cover may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

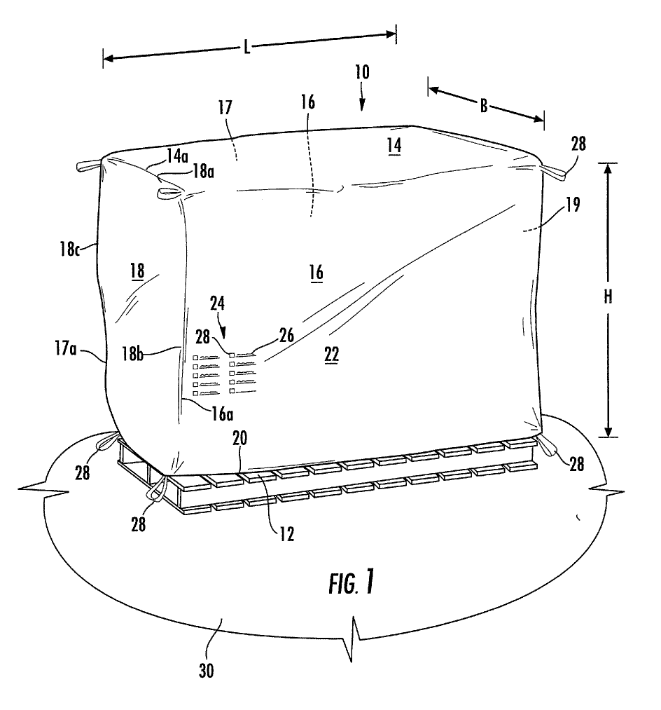

Referring to FIG. 1, a lightweight, removable cover 10 for harvested vegetative material stacked on a pallet 12, such as sod, is illustrated. The cover 10 is formed from a water-impervious, flexible material that is formed into an envelope shaped to fit snugly over the stacked material. The close fit of the cover 10 has been found useful in preventing the cover 10 from blowing off during transport or high winds. The cover includes a top panel 14, with side panels 16, 17 and end panels 18, 19 that extend downwardly from the top panel 14 to form the envelope.

In the illustrated embodiment, the underlying stacked material has a generally cube shape with a predetermined length L, breadth B and height H. The length and breadth of each cover panel corresponds to a length and breadth of a respective side of the cube, as illustrated. As such, the illustrated cover 10 has an inverted, cube shape configured to snugly surround the cube-shaped stack of material. The bottom perimeter 20 of the cover 10 is dimensioned to conform with the perimeter of the stacked material and not to enclose the pallet 12. As such, a fork lift or other lifting apparatus can freely engage the pallet 12 and move the pallet to another location without interference from the cover 10.

In some embodiments, the cover 10 may be a unitary piece of material formed into the illustrated shape. In other embodiments, one or more of the panels may be joined together into the illustrated shape. For example, in some embodiments, the top panel 14 and side panels 16,17 may be a unitary (single) sheet of material, and the end panels 18,19 are attached to the top and side panels 14, 16, 17 along respective edge portions thereof. In the illustrated embodiment, for example, end panel 18 includes top edge portion 18a and side edge portions 18b, 18c. Top edge portion 18a is secured to the edge portion 14a of the top panel 14 and end panel edge portions 18b, 18c are secured to the respective edge portions 16a, 17a of side panels 16 and 17, as illustrated. Opposite end panel 19 is similarly attached to the respective opposite edge portions of the top panel 14, and side panels 16, 17.

The respective edge portions may be joined together in any of various ways. For example the respective edge portions may be heat sealed together, may be adhesively secured together, and/or may be stitched together, for example, via string.

The present invention is not limited, however, to the illustrated embodiment wherein end panels 18, 19 are attached to the top and side panels 14, 16, 17. In other embodiments, the top panel 14 and end panels 18, 19 may be a unitary sheet of material, and the side panels 16, 17 are attached to the top and end panels 14, 18, 19 along respective edge portions thereof.

The cover 10 is formed from a lightweight, flexible material that provides the needed protection from the elements including being impervious to water and retaining moisture. Suitable materials include those formed from a polymer or polymeric material in the form of a film, sheet, cloth or the like. The term “polymer” or “polymeric material” refers to a material derived from a macromolecule formed by the chemical union of 5 or more monomers. Generally, polymers include homopolymers, copolymers such as, for example, block, graft, random and alternating copolymers, terpolymers, etc., and blends and modifications thereof. The term “polymer” shall also include all possible geometrical or spatial configurations of the molecule, i.e., the configurations include isotactic, sydiotactic and atactic symmetrics. The polymeric material includes polyolefins, polyesters, polyetheresters, polyacrylics and polyamides. In one embodiment, the polymer is a polyolefin such as polyethylene, linear low density polyethylene, high density polyethylene, polypropylene, poly(1-butene), poly(2-butene), poly(1-pentene), poly(2-pentene), poly(3-methyl-1-pentene), poly(4-methyl-1-pentene), 1,2-poly-1,3-butadiene, 1,4-poly-1,3-butadiene, polyisoprene, polychloroprene, polyacrylonitrile, poly(vinylacetate), poly(vinylidene chloride), polystyrene, and the like.

The cover material may be woven, nonwoven, or a combination of woven and nonwoven materials. The cover material may be a single layer of material or may be a laminate of two or more layers of one or more polymeric materials. In one embodiment, the cover material can be a nonwoven polyethylene available from, for example, Lumber Packaging, Eureko, Calif.

In some embodiments, elastic material may be used in selective locations of the cover 10 such that the cover 10 can be stretched to some degree when being installed and removed from a stack of material. This also facilitates a tighter fit when the material is not stacked neatly on a pallet.

The cover material is impervious to liquids, such as water. In some embodiments, the impervious characteristic of the cover 10 is created by the application of a chemical treatment or other coating to the cover 10, and can be applied by spraying, extrusion, and other materials known to those skilled in the art.

In some embodiments, the outside surface of each cover panel is light and heat-reflective to reduce heating of the covered material. For example, the outer surface of each panel is painted, stained, and/or coated to have an opaque, light color, such as white. In some embodiments, the inside surface of each panel is non-reflective. For example, the inside surface of each panel may be painted, stained, and/or coated to have an opaque, dark color, such as black.

One or more of the panels may include various types of indicia on an outer surface thereof. Promotional indicia, instructional and other informational indicia may be provided. For example, marketing information related to a vegetative material producer may be provided on the cover 10, instructional information may be provided on the cover that describes use and/or care of the vegetative material under the cover 10, etc. In the illustrated embodiment, side panel 16 includes an outer surface 22 with indicia 24 thereon. The illustrated indicia 24 includes a list 26 of information with check boxes 28 adjacent thereto. The list 26 may, for example, be a list of the possible sod types enclosed by the cover 10, and/or other product-related information. One or more check boxes 28 may be marked to indicate the contents of the pallet 12, thereby facilitating quick identification of what is covered by the cover 10.

In some embodiments, a cover 10 may be provided with loops 28 or other types of handles that can be gripped by a worker and used to facilitate installation of the cover 10 on stacked material and removal of the cover 10 from stacked material. In addition to facilitating cover installation and removal, loops 28 may be utilized to secure or anchor the cover 10 to a pallet 12, to the ground 30, and/or to another object (e.g., a truck bed, etc.).

In the illustrated embodiment, loops 28 are provided at various locations near the top panel 14 and near the bottom perimeter 20 of the cover 10. However, the cover of the present invention is not limited to the illustrated location or number of loops 28. Loops or other types of handles may be provided in any of various locations and various numbers thereof may be utilized, without limitation. In some embodiments, when one or more panels are stitched together to form the cover 10, extra stitching may be utilized to form a loop 28. In other embodiments, loops 28 may be separate articles attached to the cover 10.

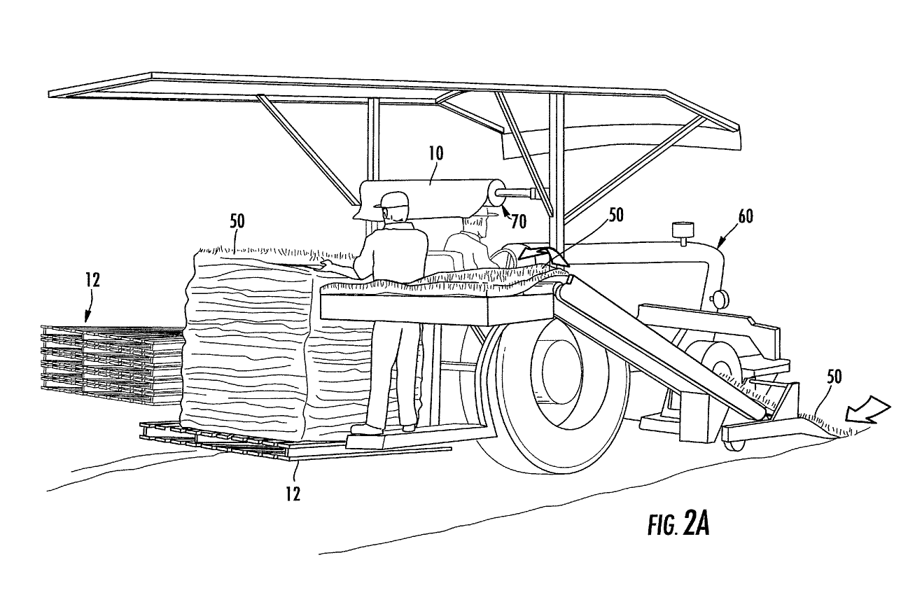

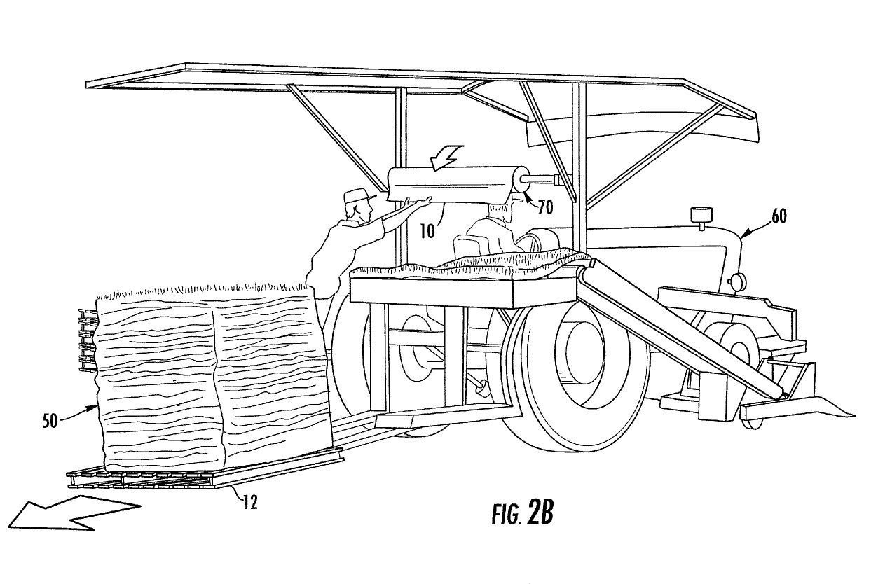

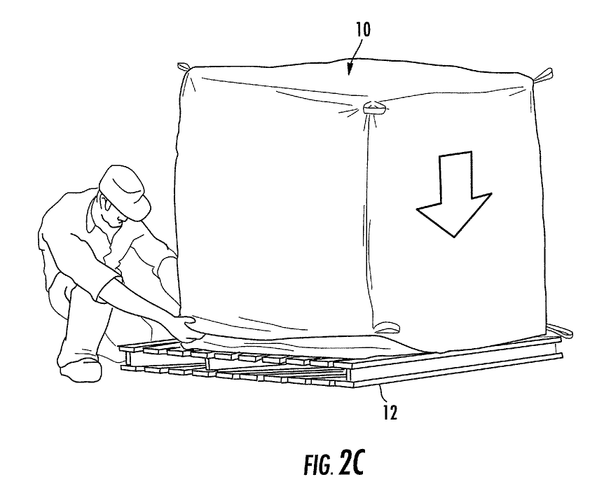

Referring to FIGS. 2A-2C, a method of harvesting vegetative material, such as sod, is illustrated. Strips of sod 50 are removed from underlying soil, for example, via a sod harvesting apparatus 60. The sod 50 is stacked on a pallet 12 to form a shape of predetermined length, breadth and height (e.g., a generally cube shape). A roll 70 of covers 10 is rotatably mounted to the harvesting apparatus 60 in a location that is convenient to workers stacking the sod 50. A cover 10 is removed from the roll 70 (FIG. 2B) by a worker and the stacked sod is covered with the cover 10 (FIG. 2C). As illustrated, the cover 10 has a shape corresponding to the shape of the stacked sod 50 and fits closely thereover. However, the cover 10 does not enclose the underlying pallet 12, as illustrated, and does not interfere with movement of the pallet 12.

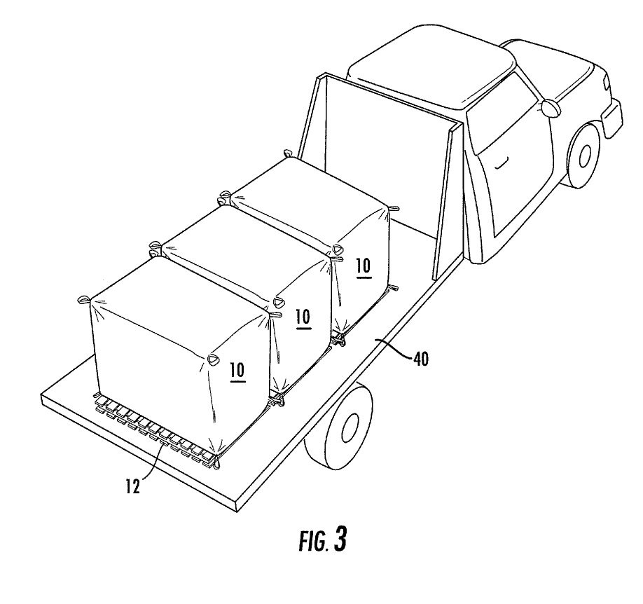

Referring to FIG. 3, a plurality of covered stacks of sod (or other harvested vegetative material) are placed in adjacent, abutting relationship in an array for transport or storage. In the illustrated arrangement, the covered stacks are placed on a truck flat bed 40 for transportation. This arrangement has been found to provide additional protection against the elements. Another benefit of this arrangement is that when one or more pallets of covered material is moved, the remaining pallets of material remain covered. Conventionally, where tarpaulins are used, the entire load of a truck bed is typically uncovered even when only one pallet is to be unloaded therefrom. By covering individual pallets of material, the underlying vegetative material is better protected from the elements, can retain moisture longer, can stay fresher and greener longer, etc.

The following example further illustrates the invention.

### EXAMPLE

A removable cover formed from a nonwoven polyethylene available from Lumber Packaging was provided. The cover's dimensions were 36″×52″×52″.

| | | | Sod Shield Protected | | | | Outside Climate | |
|---|---|---|---|---|---|---|---|---|
| | Control Pallet | | pallet #1 | pallet #2 | pallet #3 | | Conditions | |
| Days from | (no shield) | Comments On | Inside soil | Inside soil | Inside soil | Comments On | Air | |
| Harvest | Inside soil temp | Turf Quality | temp | temp | temp | Turf Quality | Temperature | RH % |
| Harvest | 89.6 | Good | 89.7 | 85.3 | 90.1 | Good | 82.3 | 50% |
| Harvest + 1 Day | 86 | Good/Top dry | 85.5 | 84.2 | 82.5 | Good | 87.1 | 37% |
| Harvest + 2 Days | 86.5 | Fair/top, sides dry | 84.2 | 85 | 83.8 | Good | 88.9 | 81% |
| Harvest + 3 Days | 96.9 | Poor/inside | 87 | 88.7 | 84.2 | Fair/inside | 91.2 | 78% |
| | | turning | | | | turning | | |
| Harvest + 4 Days | 99.3 | Poor | 87.8 | 89.1 | 87 | Poor | 89.9 | 70% |

Soil probes were inserted halfway down the pallet and 24″ inside the middle.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A removable cover for harvested vegetative material stacked on a pallet in a shape of predetermined length, breadth and height, the cover comprising:
a top panel; and
side and end panels extending downwardly from the top panel to form an envelope shaped to fit snugly over the stacked material without enclosing the pallet, wherein the length and breadth of each panel corresponds to a respective portion of the shape of the stacked material, wherein each panel comprises a flexible material that is impervious to moisture, and wherein an outside surface of each panel is light and heat-reflective.

2. The cover of claim 1, wherein an inside surface of each panel is non-reflective.

3. The cover of claim 1, wherein an outside surface of each panel has an opaque, light color, and wherein an inside surface of each panel has an opaque, dark color.

4. The cover of claim 1, wherein one or more of the panels comprises promotional indicia on an outside surface thereof.

5. The cover of claim 1, wherein one or more of the panels comprises instructional indicia on an outside surface thereof, wherein the instructional indicia describes use and/or care of the vegetative material.

6. The cover of claim 1, wherein one or more of the panels comprises polyolefin.

7. The cover of claim 1, wherein one or more of the panels comprises woven and/or nonwoven material.

8. The cover of claim 1, wherein one or more of the panels comprises elastic material.

9. The cover of claim 1, wherein the top and end panels comprise a unitary sheet of material, and wherein the side panels are attached to the top and end panels along respective edge portions thereof.

10. The cover of claim 1, wherein the top and side panels comprise a unitary sheet of material, and wherein the end panels are attached to the top and side panels along respective edge portions thereof.

11. The cover of claim 1, further comprising loops extending from one or more panels that facilitate installation of the cover over the stacked material.

12. The cover of claim 1, wherein the stacked material has a generally cube shape of predetermined length, breadth and height, and wherein the length and breadth of each panel corresponds to a length and breadth of a respective side of the cube.

13. A removable cover for harvested sod stacked on a pallet in a cube shape of predetermined length, breadth and height, the cover comprising:
a top panel; and
side and end panels extending downwardly from the top panel to form an envelope shaped to fit snugly over the stacked sod without enclosing the pallet, wherein the length and breadth of each panel corresponds to a length and breadth of a respective side of the cube, wherein each panel comprises a flexible material that is impervious to moisture, wherein an outside surface of each panel is light and heat-reflective, and wherein an inside surface of each panel has an opaque dark color.

14. The cover of claim 13, wherein an outside surface of each panel has an opaque, light color, and wherein an inside surface of each panel has an opaque, dark color.

15. The cover of claim 13, wherein one or more of the panels comprises promotional indicia on an outside surface thereof.

16. The cover of claim 13, wherein one or more of the panels comprises indicia on an outside surface thereof, wherein the indicia provides information about the sod.

17. The cover of claim 13, wherein one or more of the panels comprises instructional indicia on an outside surface thereof, wherein the instructional indicia provides information about installation and/or care of the sod.

18. The cover of claim 13, further comprising loops extending from one or more panels that facilitate installation and removal of the cover over the stacked sod.

19. A method of harvesting sod, comprising:
a) removing strips of sod from underlying soil;
b) stacking the strips of sod on a pallet to form a shape of predetermined length, breadth and height; and
c) covering the stacked sod with a cover, wherein the cover includes a top panel, and side and end panels extending downwardly from the top panel to form an envelope shaped to fit snugly over the stacked sod without enclosing the pallet, wherein the length and breadth of each panel corresponds to a respective portion of the shape of the stacked sod, wherein each panel comprises a flexible material that is impervious to moisture, and wherein an outside surface of each panel is light and heat-reflective.

20. The method of claim 19, further comprising repeating steps a) through c) to provide a plurality of covered stacks of sod, and placing the plurality of covered stacks of sod in adjacent, abutting relationship in an array.

21. The method of claim 19, wherein step b) comprises stacking the strips of sod on the pallet in a flat configuration.

22. The method of claim 19, wherein step b) comprises stacking the strips of sod on the pallet in a rolled configuration.

23. The method of claim 19, wherein step a) comprises removing the sod strips from underlying soil via a sod harvesting apparatus, and wherein the sod harvesting apparatus includes a plurality of the covers in a roll rotatably secured thereto.

24. A method of harvesting sod, comprising:
a) removing strips of sod from underlying soil via a sod harvesting apparatus;
b) stacking the strips of sod on a pallet to form a shape of predetermined length, breadth and height;
c) removing a cover from a roll of covers rotatably secured to the sod harvesting apparatus; and
d) covering the stacked sod with the cover, wherein the cover includes a top panel, and side and end panels extending downwardly from the top panel to form an envelope shaped to fit snugly over the stacked sod without enclosing the pallet, wherein the length and breadth of each panel corresponds to a respective portion of the shape of the stacked sod, wherein each panel comprises a flexible material that is impervious to moisture, and wherein an outside surface of each panel is light and heat-reflective.

25. The method of claim 19, further comprising repeating steps a) through d) to provide a plurality of covered stacks of sod, and placing the plurality of covered stacks of sod strips in adjacent, abutting relationship in an array.
